(19) United States
(12) Patent Application Publication
(10) Pub. No.: US 2018/0203475 A1
(43) Pub. Date: Jul. 19, 2018

(54) USER CONTROL DEVICE WITH AUTOMATIC MIRRORING AND LEVELING SYSTEM FOR SEMI-TRANSPARENT DISPLAY

(71) Applicant: Johnson Controls Technology Company, Auburn Hills, MI (US)

(72) Inventors: Nicholas S. Van Derven, Wauwatosa, WI (US); Wesley J. Irek, Oak Creek, WI (US); Michael J. Ajax, Milwaukee, WI (US); Justin J. Seifi, Cedarburg, WI (US)

(73) Assignee: Johnson Controls Technology Company, Auburn Hills, MI (US)

(21) Appl. No.: 15/862,912

(22) Filed: Jan. 5, 2018

Related U.S. Application Data
(60) Provisional application No. 62/446,296, filed on Jan. 13, 2017.

(51) Int. Cl. G05D 23/19; F24F 11/61; F24F 11/65; F24F 11/88; F24F 11/64; F24F 11/47; F24F 140/60

(52) U.S. Cl. CPC G05D 23/1917; G05D 23/1919; F24F 11/61; F24F 2140/60; F24F 11/88; F24F 11/64; F24F 11/47; F24F 11/65

(57) ABSTRACT

A user control device includes an electronic display, an orientation sensor, and a controller. The electronic display has a substantially transparent front surface and a substantially transparent rear surface opposite the front surface. The orientation sensor is configured to detect an orientation of the electronic display. The controller is configured to modify visual media presented by the electronic display based on the orientation of the electronic display. The visual media are presented as non-mirrored images that appear non-mirrored when viewed through the front surface and appear mirrored when viewed through the rear surface, in response to a determination that the electronic display has a first orientation. The visual media are presented as mirrored images that appear mirrored when viewed through the front surface and appear non-mirrored when viewed through the rear surface, in response to a determination that the electronic display has a second orientation.

### CROSS-REFERENCE TO RELATED PATENT APPLICATION

This application claims the benefit of and priority to U.S. Provisional Patent Application No. 62/446,296 filed Jan. 13, 2017, the entire disclosure of which is incorporated by reference herein.

### BACKGROUND

The present disclosure relates generally to a user control device for a building management system. A building management system (BMS) is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The user control device may be a device that can be used to control the operation of a system within the BMS. One such example of a device is a thermostat for an HVAC system. The thermostat may be configured to control a heating or cooling system or an air conditioner of the HVAC system. The thermostat may include or be coupled to a temperature sensor for sensing the current temperature, and a user interface for receiving one or more settings or selections from a user relating to the HVAC system.

### SUMMARY

One implementation of the present disclosure is a user control device including an electronic display, an orientation sensor, and a controller. The electronic display is configured to present visual media including dynamic graphics and text. The electronic display has a substantially transparent front surface through which the visual media presented by the electronic display are visible and a substantially transparent rear surface, opposite the front surface, through which the visual media presented by the electronic display are visible. The orientation sensor is configured to detect an orientation of the electronic display. The controller is configured to modify the visual media presented by the electronic display based on the orientation of the electronic display. The visual media are presented as non-mirrored images that appear non-mirrored when viewed through the front surface and appear mirrored when viewed through the rear surface, in response to a determination that the electronic display has a first orientation. The visual media are presented as mirrored images that appear mirrored when viewed through the front surface and appear non-mirrored when viewed through the rear surface, in response to a determination that the electronic display has a second orientation.

In some embodiments, the user control device is a thermostat including a temperature sensor configured to measure a temperature of a building space in which the thermostat is located. The controller may be configured to operate the thermostat to control the temperature of the building space.

In some embodiments, the user control device includes a housing coupled to the electronic display and containing the controller and the orientation sensor and a hinge coupled to the housing and configured to hingedly connect the housing to a mounting surface to allow the housing and the electronic display to pivot relative to the mounting surface.

In some embodiments, the user control device includes a wall plate fixed to the mounting surface and hingedly connected to the housing via the hinge. The housing may be hingedly connected to the mounting surface via the wall plate.

In some embodiments, the electronic display includes a bottom edge coupled to the housing and a top edge opposite the bottom edge. The hinge may be coupled to the housing such that the housing and the electronic display pivot about an axis substantially parallel to both the bottom edge and the top edge.

In some embodiments, the electronic display includes a first side edge coupled to the housing and a second side edge opposite the first side edge. The hinge may be coupled to the housing such that the housing and the electronic display pivot about an axis substantially parallel to both the first side edge and the second edge.

In some embodiments, the orientation sensor is configured to configured to detect the orientation of the electronic display relative to a direction of gravity. In some embodiments, the controller is configured to determine whether the electronic display has the first orientation or the second orientation based on the orientation of the electronic display relative to the direction of gravity.

In some embodiments, the controller is configured to cause the electronic display to display a level graphic that indicates the orientation of the electronic display relative to the direction of gravity. In some embodiments, the controller is configured to rotate the visual media to maintain a stable orientation of the visual media relative to the direction of gravity.

In some embodiments, the controller is configured to determine that the electronic display has the first orientation in response to a determination that a component of the direction of gravity points from a top edge of the electronic display toward a bottom edge of the electronic display. In some embodiments, the controller is configured to determine that the electronic display has the second orientation in response to a determination that the component of the direction of gravity points from the bottom edge of the electronic display toward the top edge of the electronic display.

In some embodiments, the user control device includes a position sensor configured to detect a position of a user relative to the electronic display. In some embodiments, the controller is configured to determine whether the electronic display has the first orientation or the second orientation based on the position of the user relative to the electronic display.

In some embodiments, the controller is configured to determine that the electronic display has the first orientation in response to a determination that the user is positioned to view the visual media through the front surface of the electronic display. In some embodiments, the controller is configured to determine that the electronic display has the second orientation in response to a determination that the user is positioned to view the visual media through the rear surface of the electronic display.

In some embodiments, the visual media include installation or de-installation instructions. The controller may be configured to cause the instructions to be presented as non-mirrored images while the electronic display is oriented upright during installation or de-installation and as mirrored images while the electronic display is oriented upside down during installation or de-installation.

Another implementation of the present disclosure is a method for operating a user control device. The method includes presenting visual media including dynamic graphics and text via an electronic display of the user control device. The electronic display includes a substantially transparent front surface through which the visual media presented by the electronic display are visible and a substantially transparent rear surface, opposite the front surface, through which the visual media presented by the electronic display are visible. The method includes detecting the orientation of the electronic display using an orientation sensor and modifying the visual media presented by the electronic display based on the orientation of the electronic display. The visual media are presented as non-mirrored images that appear non-mirrored when viewed through the front surface and appear mirrored when viewed through the rear surface, in response to a determination that the electronic display has a first orientation. The visual media are presented as mirrored images that appear mirrored when viewed through the front surface and appear non-mirrored when viewed through the rear surface, in response to a determination that the electronic display has a second orientation.

In some embodiments, the orientation detected by the orientation sensor is an orientation of the electronic display relative to a direction of gravity. In some embodiments, the method includes determining whether the electronic display has the first orientation or the second orientation based on the orientation of the electronic display relative to the direction of gravity.

In some embodiments, the method includes determining that the electronic display has the first orientation in response to a determination that a component of the direction of gravity points from a top edge of the electronic display toward a bottom edge of the electronic display. In some embodiments, the method includes determining that the electronic display has the second orientation in response to a determination that the component of the direction of gravity points from the bottom edge of the electronic display toward the top edge of the electronic display.

In some embodiments, causing the electronic display to display a level graphic that indicates the orientation of the electronic display relative to the direction of gravity. In some embodiments, rotating the visual media to maintain a stable orientation of the visual media relative to the direction of gravity.

In some embodiments, the method includes detecting a position of a user relative to the electronic display using a position sensor and determining whether the electronic display has the first orientation or the second orientation based on the position of the user relative to the electronic display.

In some embodiments, the method includes determining that the electronic display has the first orientation in response to a determination that the user is positioned to view the visual media through the front surface of the electronic display. In some embodiments, the method includes determining that the electronic display has the second orientation in response to a determination that the user is positioned to view the visual media through the rear surface of the electronic display.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a front perspective view of a user control device, according to an exemplary embodiment.

FIG. 2 is a perspective view of the user control device of FIG. 1, with the user control device body shown in an open position, according to an exemplary embodiment.

FIG. 3 is a front view of the user control device of FIG. 1 showing a front surface of a semi-transparent display screen, according to an exemplary embodiment.

FIG. 4 is a front view of the user control device of FIG. 1, with the user control device flipped and upside-down showing a rear surface of the semi-transparent display screen, according to an exemplary embodiment.

FIG. 5 is a view of the user control device of FIG. 1 illustrating an accelerometer configured to measure the force of gravity on the device, according to an exemplary embodiment.

FIG. 6 is a front view of the user control device of FIG. 1, illustrating a level displayed on the semi-transparent display screen, according to an exemplary embodiment.

FIG. 7 is a front view of the user control device of FIG. 1, with a vertical hinge, according to an exemplary embodiment.

FIG. 8 is a front view of the user control device of FIG. 1, with the user control device rotated at an angle upon a vertical hinge, according to an exemplary embodiment.

FIG. 9 is a block diagram of a controller of the user control device, according to an exemplary embodiment.

### DETAILED DESCRIPTION

Referring generally to the figures, a user control device with a transparent or semi-transparent display screen is shown, according to an exemplary embodiment. The user control device can be configured to adjust the content of the display (i.e., text and graphics displayed via the transparent or semi-transparent display screen) as the user control device rotated or reoriented relative to a wall or mounting surface. For example, the user control device can automatically flip, mirror, level, or otherwise adjust the text and graphics presented via the transparent or semi-transparent display screen when the user control device is being installed, physically connected or disconnected from a wall or other unit, or otherwise moved by a user.

In some embodiments, the user control device may display instructions on its display relating to usage of the device. For example, the user control device may display installation or de-installation instructions as the device is being installed by a user. During installation, de-installation, or other movement, the display may be at an angle compared to the field of view of the user operating the user control device, which may cause difficulty for the user reading the contents of the display. The systems and methods described herein may be used to adjust the contents on the display to make the contents readable to the user, no matter the current orientation of the device.

As described in the present disclosure, the user control device may include one or more sensors configured to detect the orientation of the device relative to the user. Using the sensor data, the user control device may manipulate the display such that the contents of the display are easily decipherable. For example, if the display is a transparent or semi-transparent display and the user control device is being held backwards (e.g., the front of the device is facing away from the user), the contents of the display can be flipped and/or mirrored such that the contents of the display are presented in proper orientation and direction to a user viewing the rear of the device. As another example, the contents of the display may be rotated as the user control device is rotated or tilted during installation.

In some embodiments, the one or more sensors may further be used to level the user control device during installation. For example, as the device is being mounted on a wall, a level status can be displayed on the display, allowing the user to see if the device is level when mounted on the wall. The level status may be updated in real-time or near real-time, allowing the user to adjust the orientation of the device until the device is level against a wall or other mounting surface.

The user control device may include a transparent or semi-transparent display that allows content to be presented on either side of the display. For example, when the back of the display is facing the user, the device may be configured to flip or mirror the display, to allow the user to easily read the display from the rear side of the display.

As one example, the user control device may be a thermostat for an HVAC system for a BMS. However, it should be understood that the systems and methods described herein are applicable for any other type of user control device that can be installed for a subsystem of a BMS. Further, the systems and methods described herein may be implementable for any type of device that includes a transparent or semi-transparent display (e.g., a tablet, laptop, phone, or other mobile device with a transparent or semi-transparent display). As further examples, a door with a transparent or semi-transparent display (e.g., a refrigerator door, cabinet door, etc.) may implement the systems and methods described herein.

### User Control Device With Semi-Transparent Display

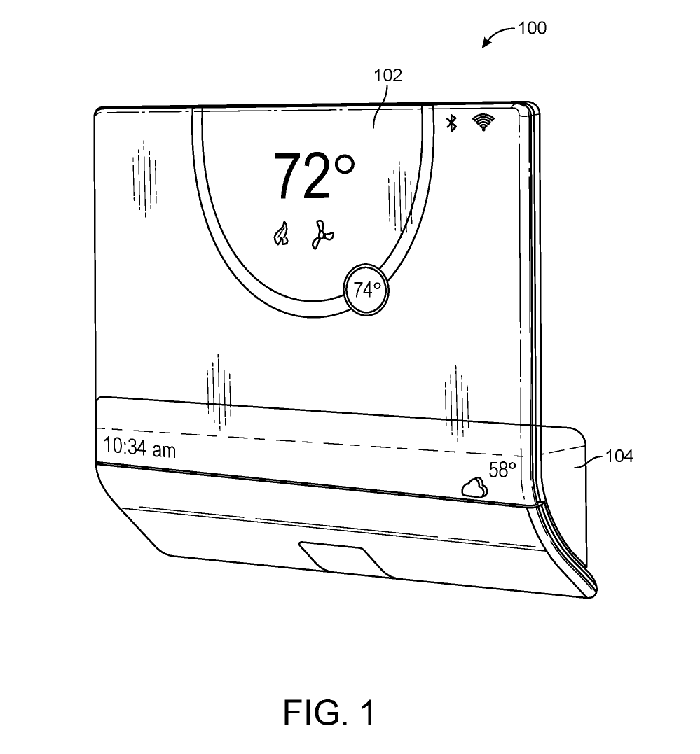

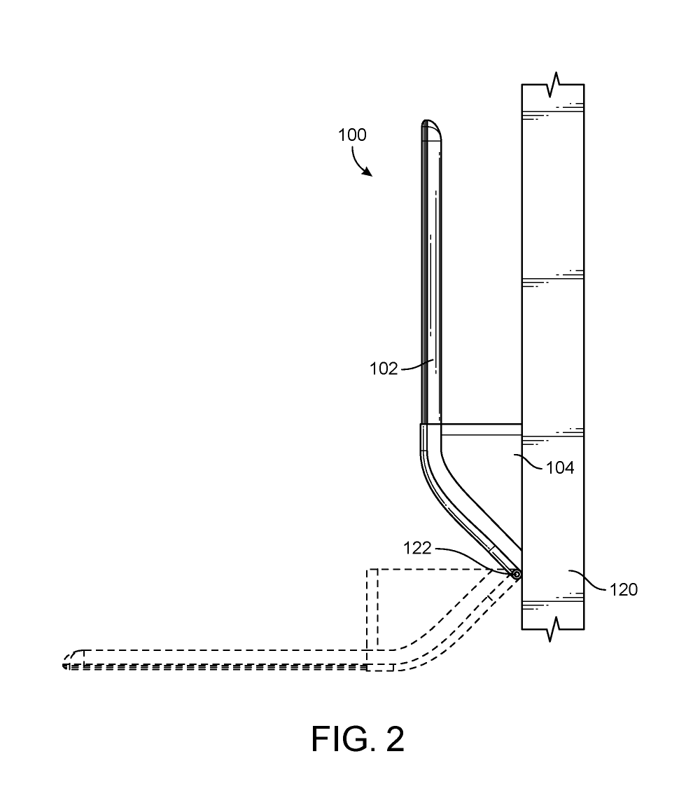

Referring generally to FIGS. 1-2, a multi-function user control device 100 is shown, according to an exemplary embodiment. User control device 100 can be, for example, a thermostat including central control hub functionality (e.g., the user may be able to control the ambient atmosphere in a building area via user control device 100). A thermostat is shown as the example device in FIG. 1 for the purposes of illustration only. User control device 100 may be communicatively coupled to HVAC equipment and/or non-HVAC equipment (lighting systems, blind control systems, security systems, entertainment devices or systems, refrigeration systems, etc.), to one or more remote sensors, to one or more remote servers, or to any other information source that may provide data for use by user control device 100 to automate control of a building area. User control device 100 may communicate information to a user via display 102, such as the status of equipment or status of the room (e.g., temperature, humidity, etc.). User control device 100 may further receive inputs from a user to change settings, set up new equipment, etc.

User control device 100 can be mounted on a wall 120 or other suitable mounting location (e.g., a vertical wall within a home or building, a ceiling, a floor, a surface of an object within a building space, a ledge, a dashboard, furniture, a vehicle seat or other vehicle surface, etc.). In some embodiments, user control device 100 can be mounted in a location that allows it to communicate wirelessly with one or more remote sensors or devices. In some embodiments, user control device 100 is mounted on a wall in front of an electrical gang box and receives electrical connections and/or data connections through the gang box. In other embodiments, user control device 100 is attached to a wall without requiring a gang box. In some embodiments, user control device 100 is detachable. User control device 100 is shown to include a display 102. In some embodiments, display 102 may be a touch-sensitive display. In the embodiments of the present disclosure, display 102 is a transparent or semi-transparent display in which the contents of the display are visible from any angle.

User control device 100 is shown to include a display 102. Display 102 may be a touchscreen or other type of electronic display configured to present information (e.g., dynamic graphics, text, and/or other visual media) to a user in a visual format (e.g., as text, graphics, etc.) and receive input from a user (e.g., via a touch-sensitive panel). Display 102 can be used to display status information (e.g., current temperature, heating/cooling settings, errors, etc.) and can be used to set up communications between user control device 100 and remote sensors or equipment. In some embodiments, user control device 100 includes some or all of the functionality described in U.S. patent application Ser. No. 15/146,134 filed May 4, 2016, the entire disclosure of which is incorporated by reference herein.

In the present disclosure, display 102 can be substantially transparent. For example, display 102 may include a transparent or translucent display screen, or a semi-transparent or semi-translucent display screen. The display screen may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. Display 102 may be configured to present visual media (e.g., text, graphics, etc.) without requiring a backlight. Advantageously, display 102 may be transparent, semi-transparent, translucent, or semi-translucent to allow the surface behind display 102 to be seen through display 102. For example, if user control device 100 is mounted on a wall, the wall may be visible through display 102. This allows user control device 100 to blend in to the surface upon which user control device 100 is mounted.

Display 102 can provide a variety of information to a user, either when prompted by the user, or when pushed to the user, without prompting, by another system (e.g., a security system, a weather monitoring system, etc.) or remote sensors (e.g., a smoke detector, a fire detector, a malfunctioning sensor, etc.). Display 102 in FIGS. 1-2 is shown to have a generally horizontal orientation; in other embodiments display 102 may have a generally vertical orientation, or may have a non-rectangular shape. The size and shape of display 102 (and user control device 100 in general) may vary depending on the space in which user control device 100 is installed and the functionality desired for user control device 100. For example, user control device 100 can have any of the sizes, shapes, or other configurations disclosed in U.S. patent application Ser. No. 29/576,515 filed Sep. 2, 2016, and/or U.S. patent application Ser. No. 15/146,763 filed May 4, 2016. Both these patent applications are incorporated by reference herein in their entireties.

Housing 104 may be attached to display 102 along one or more edges or surfaces of display 102. Housing 104 provides a structure to mount user control device 100 to a wall or other surface. Housing 104 may be formed from a variety of materials (e.g., polymers, metals, composite materials, laminates, etc.) and may have a variety of different appearances or finishes. In some embodiments, display 102 is detachable from housing 104. Housing 104 can include a charging circuit for display 102. Housing 104 may contain a variety of electronic components configured to perform control functions (e.g., a circuit board, memory, a processor, etc.), facilitate communications with remote sensors or equipment (e.g., a WiFi transceiver, a cellular transceiver, a communications interface, etc.), and provide a visual display via display 102 (e.g., a video card or module, etc.).

In some embodiments, housing 104 contains one or more sensors. For example, housing 104 may contain a temperature sensor, a humidity sensor, a motion sensor, an air quality sensor (e.g., carbon monoxide, carbon dioxide, allergens, smoke, etc.), a proximity sensor (e.g., NFC, RFID, Bluetooth, etc.), a camera, a microphone, a light sensor, a vibration sensor, or any other type of sensor configured to measure a variable state or condition of the environment in which user control device 100 is installed. The various sensors may be used to adjust operation of user control device 100. For example, the proximity sensor may be used to turn on or turn off display 102 based on the proximity of a user to the device. As another example, sensors such as a camera, light sensor, or optical sensor may monitor the activity in a room or space and activate or update display 102 based on the activity.

In some embodiments, user control device 100 may receive sensor data from one or more sensors located external to user control device 100 via a data communications link. For example, one or more sensors may be installed in a gang box behind user control device 100, installed a separate gang box mounted within the same wall to which user control device 100 is mounted, or otherwise located throughout the room or space monitored or controlled by user control device 100 (e.g., in a wall, in a ceiling panel, in an open volume of the room or space, in a duct providing airflow to the room or space or receiving airflow from the room or space, etc.).

As shown more particularly in FIG. 2, housing 104 of user control device 100 may be used to mount user control device 100 to wall 120 or another surface. In some embodiments, a mounting plate may be coupled to housing 104 (or to wall 120). The mounting plate can affix user control device 100 to wall 120 or another surface via any suitable method such as mechanical fasteners, screws, nails, adhesives, hooks, etc. The mounting plate can include an opening to allow connection of one or more wires to user control device 100 and any other features to ease installation of the device.

In some embodiments, user control device 100 may be pivotable between an upright portion and a lowered portion during installation of the device. In such an embodiment, user control device 100 may include a hinge 122 that allows the device to be pivotably connected to wall 120 or another surface. As shown in FIG. 2, hinge 122 allows user control device 100 to be pivoted between an upright position and a lowered position that allows the user to access a gang box or other electrical components behind the device, or to remove the device. As shown in FIG. 2, hinge 122 is located at an intersection of the bottom of user control device 100 and wall 120; in other embodiments, the assembly may include any number of hinges in any location to allow user control device 100 to be pivoted in any direction. Hinge 122 can be any suitable hinge, and the body of user control device 100 can include one or more rods along its body on which a mounting plate can snap onto or which can be inserted into an opening in the housing of the device. It should be understood that the hinge as described in FIG. 2 is just an example of an option for securing user control device 100 to wall 120, and that other methods for securing user control device 100 while still allowing the movement of user control device 100 relative to wall 120 are implementable.

In a down or open position (as shown by the dashed lines), various electronics of user control device 100 or the gang box may be accessible to the user for connection or disconnection of the device. During an installation or connection process, user control device 100 may first be secured (e.g., via hinge 122), then lifted into a closed or upright position. The user may further secure user control device 100 in position via any additional fastening method or device, such as clips, snaps, magnets, etc.

In some embodiments, display 102 is substantially transparent (e.g., transparent or semi-transparent). Accordingly, information presented by display 102 can be viewed from both the front of display 102 (e.g., from the left in FIG. 2) and from the rear of display 102 (e.g., from the right in FIG. 2). Both the front surface and the rear surface may be transparent or substantially transparent. Display 102 can be configured to orient information to be viewed through the front surface of display 102 when user control device 100 is in the upward or installed position. Similarly, display 102 can be configured to orient information to be viewed through the rear surface of display 102 while user control device 100 is in the downward position. User control device 100 can detect when it is in the upward or downward position. For example, an orientation sensor (e.g., inclinometer, accelerometer, tilt sensor, etc.) can be used to determine whether user control device 100 is rotated in the down position or in the upright position. When user control device 100 is in the downward position, the information presented via display 102 can be flipped, rotated, mirrored, or otherwise oriented to be presented to a user viewing display 102 from the rear. Similarly, when user control device 100 is in the upward position, the information presented via display 102 can be flipped, rotated, mirrored, or otherwise oriented to be presented to a user viewing display 102 from the front. In some embodiments, information is presented through the front surface and rear surface of display 102 simultaneously. The information may be oriented for display through whichever surface of display 102 is facing a user (i.e., the front surface or the rear surface), based on the sensed orientation of display 102.

In an illustrative embodiment, the rear surface of the display 102 may display user information related to the installation of user control device 100. For example, the user information can include instructions for installing user control device 100, troubleshooting instructions, images illustrating installation steps, a wiring diagram, etc.

In some embodiments, the user information provided by display 102 includes a level display that indicates the relative rotational position or orientation of user control device 100 relative to the earth along a plane of the mounting surface. For example, the level can be used to ensure user control device 100 is perpendicular to the ground when in the upward position and mounted to the mounting structure. In some embodiments, user control device 100 includes one or more orientation sensors that are used to determine the position of the user control device 100 relative to the ground. The rotational orientation determined by the orientation sensors can be shown via the level display.

In some embodiments, the user information provided by display 102 may include information relating to the connection of various wires to user control device 100. For example, display 102 may be configured to display information relating to a HVAC wire connection process. Display 102 may provide information allowing a user to connect user control device 100 to a HVAC system (or other BMS) system.

In some embodiments, the sensors of user control device 100 can include an accelerometer that can be used to monitor the motion of the device. For example, the accelerometer may detect when user control device 100 is being moved by a user and in what direction the device is being moved. The accelerometer may further detect the current orientation of the device, as described below.

### Hinged Wall Plate

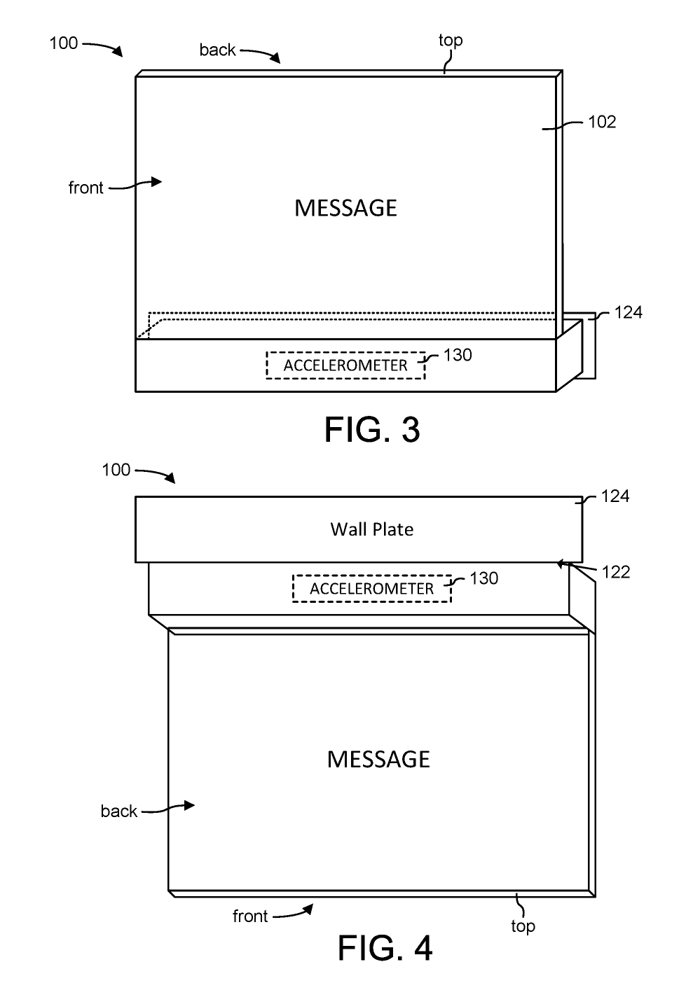

Referring also to FIGS. 3-4, a front view of user control device 100 is shown. In FIG. 3, user control device 100 is shown in an upright position, facing forward (i.e., the front surface of display 102 facing forward, the back surface of display 102 facing the wall, the top of display 102 facing upwards). User control device 100 is mounted against a wall plate 124 attaching the device to a wall (or other surface). User control device 100 may be mounted using any type of fastener (e.g., screw, nail, etc.), any type of joint or mechanism (e.g., hinge 122 of FIG. 2), or via any type of adhesive. The content of display 102 (simply shown as “message” in FIG. 3 for simplicity) is displayed in an orientation to be readable by a user viewing display 102 through the front surface of display 102. The orientation of the message shown in FIG. 3 may be the usual orientation, unaltered relative to normal operation since the device is upright and in an installed position.

In FIG. 4, user control device 100 is shown in an upside-down orientation in which display 102 is rotated downwards (e.g., rotated about a hinge 122). In some embodiments the orientation shown in FIG. 4 may occur when the user is installing or de-installing the device (i.e., attaching the device to wall plate 124 or removing the device from wall plate 124), or may be wishing to access wall plate 124 or any electronics on or around wall plate 124 and/or within housing 104. As the result of rotating user control device 100, the back surface of display 102 is now facing away from the wall and towards the user, whereas the front surface of display 102 is facing toward the wall.

As a result of display 102 being transparent or semi-transparent, the content presented via display 102 can be adjusted to make the content readable to the user when viewed through the rear surface. For example, in FIG. 4, with the back of the display 102 facing the user, the message can be flipped, rotated, and/or mirrored such that the message is presented in the same orientation from the perspective of the user, even though the message is now viewed through the back surface of the display 102 instead of the front surface of the display 102. The housing 104 of user control device 100 may include any number of sensors configured to detect movement of the device by the user. For example, sensors in the housing of user control device 100 may measure the rotation of user control device 100, to determine the angle of the display 102 relative to the user. In FIG. 4, accelerometer 130 may be used to detect that user control device 100 has been flipped a full 180 degrees, with the back of the display 102 now fully facing away from the wall and towards the user.

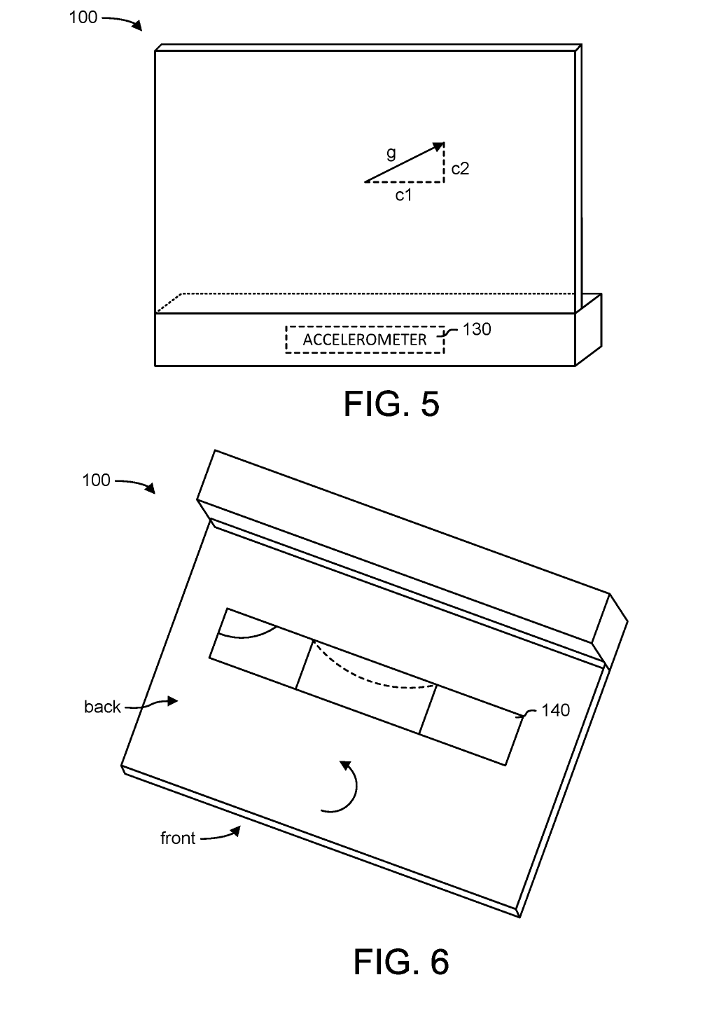

Accelerometer 130 can be configured to determine the orientation of the force of gravity relative to user control device 100 (i.e., to determine when the device is partially or fully upside-down). Referring to FIG. 5, the force of gravity g applied to user control device 100 is measured by accelerometer 130, which can be located within housing 104 and configured to rotate along with display 102. The force of gravity g has a component c1 which is parallel to the top and bottom edges of display 102 and a component c2 which is parallel to the left and right side edges of display 102. Component c2 may be positive (i.e., pointing toward the top edge of display 102) when display 102 is upside down, whereas c2 may be negative (i.e., pointing toward the bottom edge of display 102) when display 102 is top side up. If c2 is negative (i.e., the device is oriented upwards), then accelerometer 130 determines that the device is pointed upwards. If c2 is positive, the device is pointed downwards and the content of the display may be mirrored by user control device 100. The component c1 may be used in combination with the component c2 to determine the angle of the gravity vector g relative to display 102, which can be used by user control device 100 to determine how much to rotate the content presented via display 102, for example.

### Level Display

In some embodiments, user control device 100 may present an image or graphic of a level (e.g., a bubble level display 140) via display 102. User control device 100 can automatically rotate the bubble level display 140 on display 102 to provide a level display during an installation process for the device (or during another operation of the device that causes the device to be moved). As the device is being installed or moved by a user, the device may be at an angle, upside down, backwards, etc. For example, at one stage of installation, the device may be rotated as shown in FIG. 4, or rotated about an axis perpendicular to the wall as shown in FIG. 6. User control device 100 may display a representation of the current orientation of the device on the display. Referring to FIG. 6, one example representation of the orientation of user control device 100 is shown. An example bubble level display 140 is provided which illustrates the current orientation of user control device 100. More particularly, bubble level display 140 may allow the user to see the relative angle of gravity to the horizontal axis of the device (i.e., how offset the device is).

In the embodiment of FIG. 6, bubble level display 140 has a similar appearance to a physical bubble level or spirit level. When user control device 100 is installed and upright, bubble level display 140 may indicate that the device is correctly aligned by illustrating a bubble in the middle of the display (as illustrated by the dotted line in FIG. 6). However, when user control device 100 is at an angle, the bubble may be shown offset from the center in the display. As illustrated by the solid line in FIG. 6, the bubble is shown offset from the center and more particularly to the left of center, indicating that the left portion of user control device 100 is positioned higher than the right portion. Bubble level display 140 may update in real-time or near-real time, updating the position of the bubble in the display as the device is moved. Bubble level display 140 itself may be adjusted based on the current device position (e.g., the bubble level display itself may be rotated within display 102 so that it is always facing the user directly), and may be flipped or mirrored if the back of the device is currently facing the user.

The embodiment of FIG. 6, shows a bubble level display 140 that has a similar appearance to a physical bubble level or spirit level. However, in other embodiments, any type of display that can be provided in addition to or instead of the bubble level display 140 to relay level information to the user may be provided. For example, in FIG. 6, the display further includes an arrow illustrating a direction in which the user should rotate the device to level the device.

### Side Hinge

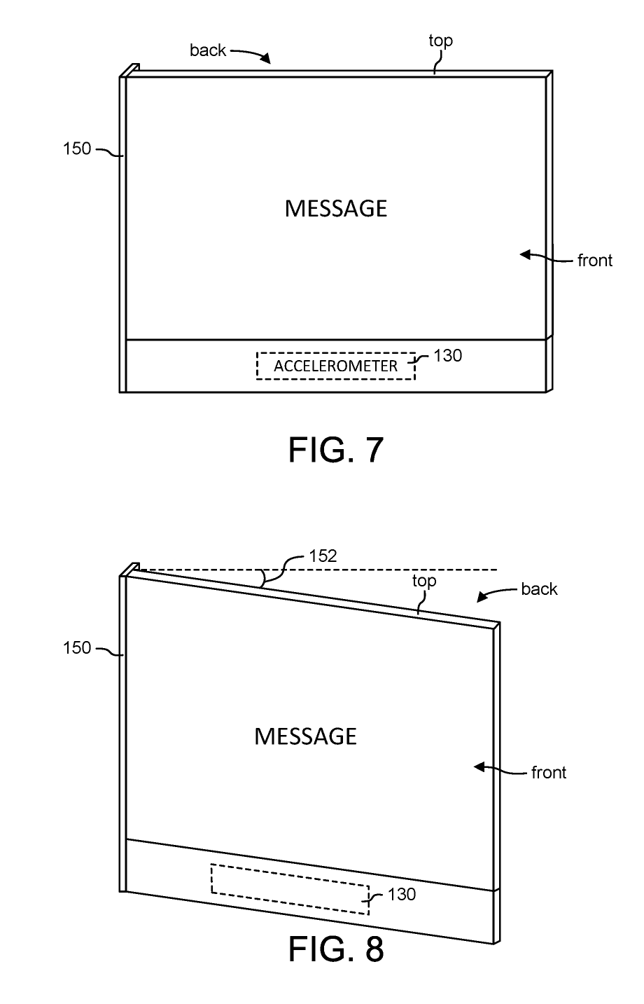

Referring now to FIGS. 7-8, another embodiment of user control device 100 is shown. In the embodiments of FIGS. 7-8, instead of having a hinge at the bottom of user control device 100, hinge 150 is located on the side of user control device 100. By having hinge 150 on the side (shown on the left side in FIGS. 7-8), user control device 100 may be rotated vertically (as shown in FIG. 8) during installation of the device or other usage of the device. In various embodiments, hinge 150 may instead be attached to the right side of user control device 100, or in any other location.

In the embodiments of FIGS. 7-8, when user control device 100 is rotated about hinge 150, accelerometer 130 may be configured to measure the level of rotation of the device. For example, accelerometer 130 may measure the angle 152 of rotation of the device. The message displayed on user control device 100 may then be rotated such that the message is still readable to the user rotating the device. For example, user control device 102 may rotate the message in the opposite direction of rotation of the device itself, allowing a user viewing the display head-on the clearest view of the contents of the display. As another example, if user control device 102 is rotated over ninety degrees, then the back of the display would be facing the user. The message may then be flipped and rotated accordingly so that the user can still read the display.

### Block Diagram

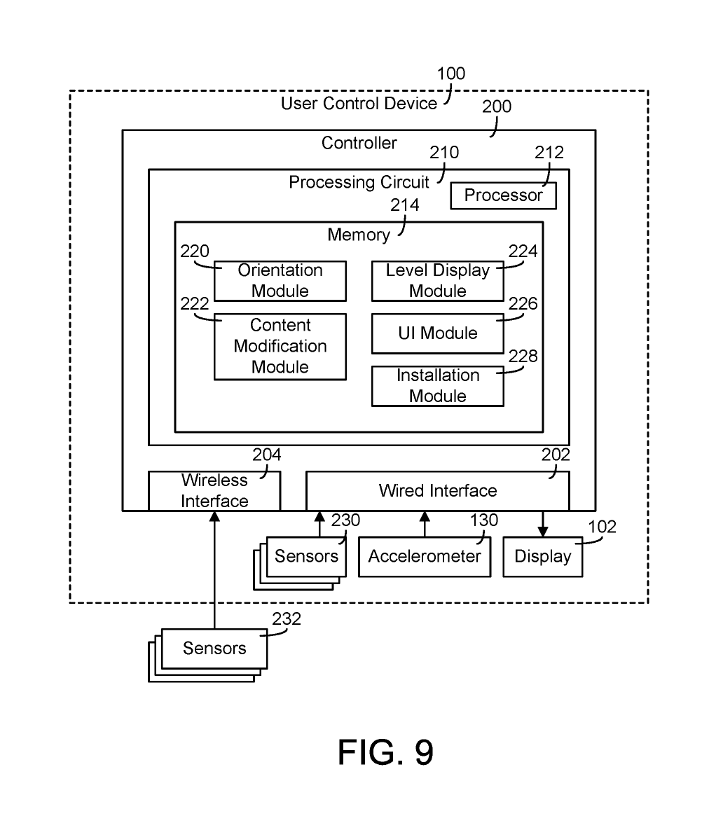

Referring to FIG. 9, a block diagram of a controller 200 of user control device 100 is shown, according to an exemplary embodiment. Controller 200 may generally be configured to implement the systems and methods described herein, in particular the adjustment of content on display 102. In some embodiments, controller 200 may be housed within housing 104. In other embodiments, one or more modules described as within controller 200 may be located remotely from user control device 100.

While the present disclosure describes controller 200 activity with regards to providing a display on the user control device, controller 200 may further control other operations of the user control device. For example, if the user control device is a thermostat, controller 200 may be generally configured to modify a setpoint for the temperature in an area. It should be understood that the activity of controller 200 may further include any activity relating to the control of one or more parameters in an area or zone, one or more operating modes of the user control device, or otherwise, in addition to the control of the display of the user control device as described in the present disclosure.

Controller 200 may include one or both of a wired interface 202 and wireless interface 204. Interfaces 202, 204 may generally facilitate communications between controller 200 and other components of user control device 100 (e.g., one or more sensors). Interfaces 202, 204 may further facilitate communications between controller 200 and devices connected to user control device 100, such as devices connected to the device via a wall mount as described above. For example, interfaces 202, 204 can facilitate wireless communications with a client device, wired or wireless communications with monitoring and reporting applications for a building area, wired or wireless communications with a master controller for a BMS, or the like. Interfaces 202, 204 may allow for communications via any protocol with any type of device (e.g., a port for sending and receiving data via an Ethernet-based link, cellular transceivers for sending and receiving data from a mobile phone, a power line communications interface, a wireless interface, etc.). As shown in FIG. 9, interfaces 202, 204 may be configured to receive sensor data from one or more sensors 230 housed within user control device 100 and one or more sensors 232 located remotely from user control device 100. Interfaces 202, 204 may further receive accelerometer 130 data, the accelerometer data used to determine adjustments to the display as described below. It should be understood that the embodiment shown in FIG. 9 with regards to interfaces 202, 204 is not limiting (i.e., the sensors and accelerometer may communicate with controller 200 either via a wired or wireless connection).

Controller 200 is shown to include a processing circuit 210 including a processor 212 and memory 214. Processor 212 can be a general purpose or specific purpose processor, an application specific integrated circuit (ASIC), one or more field programmable gate arrays (FPGAs), a group of processing components, or other suitable processing components. Processor 212 is configured to execute computer code or instructions stored in memory 214 or received from other computer readable media (e.g., CDROM, network storage, a remote server, etc.). Memory 214 can include one or more devices (e.g., memory units, memory devices, storage devices, etc.) for storing data and/or computer code for completing and/or facilitating the various processes described in the present disclosure. Memory 214 can include random access memory (RAM), read-only memory (ROM), hard drive storage, temporary storage, non-volatile memory, flash memory, optical memory, or any other suitable memory for storing software objects and/or computer instructions. Memory 214 can include database components, object code components, script components, or any other type of information structure for supporting the various activities and information structures described in the present disclosure. Memory 214 can be communicably connected to processor 212 via processing circuit 210 and can include computer code for executing (e.g., by processor 212) one or more processes described herein. When processor 212 executes instructions stored in memory 214, processor 212 generally configures controller 200 (and more particularly processing circuit 210) to complete such activities.

Memory 214 may include various modules for modifying the content to be displayed on display 102. Orientation module 220 may be configured to determine a current position of user control device 100. Orientation module 220 may receive data from accelerometer 130 and determine the current orientation of the device. For example, based on the accelerometer data, orientation module 220 may determine if the device is currently upside down, or at what angle the device is currently tilted. In some embodiments, orientation module 220 may simply determine whether the front or the back of the display is facing away from the wall (or wall mount). In some embodiments, orientation module 220 may simply determine whether the device is upside down (e.g., the top of the display is facing downwards). In some embodiments, orientation module 220 may determine a precise angle at which the device is tilted, in any of three ways (e.g., tilted from left to right, tilted from up to down, or whether the front of the display is facing a user). In some embodiments, orientation module 220 may receive feedback from an occupancy sensor relating to the current position of a user handling the device. Orientation module 220 can then determine a field of view for the user, which can be used to adjust the contents of the display to make the contents more readable to the user.

Memory 214 is shown to include a content modification module 222 configured to adjust the content to be displayed on display 102 based on the orientation of the device. Referring also to FIG. 1, content modification module 222 may generally be configured to modify the content of the display to make the contents more readable to a user. For example, if orientation module 220 determines that the back of display 102 is facing the user, content modification module 222 may mirror the content. As another example, if orientation module 220 determines that the display 102 is facing downwards, content modification module 222 may flip the content such that the content is not upside-down to the user. Content modification module 222 may further rotate the content at any angle, reflect the content, skew the content, increase or decrease the size of the content or a portion of the content, shade or highlight some or all of the content, or otherwise alter the content in any way to make the content more readable to the user while the device is not upright.

Memory 214 is shown to include a level display module 224. Referring also to FIG. 6, level display module 224 may be configured to generate the bubble level display 140 (or other type of display illustrating the orientation of the device). Level display module 224 may use orientation module 220 to determine the current status of the device, and to generate a bubble level display 140 accordingly.

Memory 214 is shown to include a user interface (UI) module 226. UI module 226 may use information from content modification module 222 to generate the display to be provided (e.g., the display as shown in FIG. 1). UI module 226 may be configured to alter the content to be displayed in accordance with the adjustments determined by content modification module 222. In some embodiments, UI module 226 may determine adjustments to the content to be displayed based on the proximity of one or more users to the display, the ambient light surrounding the display, and the like.

Memory 214 is shown to include an installation module 228. As described above, the content to be displayed on the device may be installation or de-installation instructions. Installation module 228 may provide content relating to instructions for the installation or de-installation process. UI module 226 may receive the content to be altered for the display. Further, orientation module 220 may receive instructions from installation module 228 relating to an installation or de-installation process. Orientation module 220 may determine whether the user is following proper instructions for the installation process, whether the device should be more level, and the like.

Controller 200 may further include modules relating to the operation of the device, such as a touchscreen module or user input module for receiving user input relating to the display of information on the device. Further, controller 200 may include any number of modules relating to the operation of the device. For example, if user control device 100 is a thermostat, controller 200 may include any number of modules for determining a temperature setpoint, for causing heating or cooling instructions to be provided to the BMS, and the like.

In some embodiments, user control device 100 includes a power supply, such as a battery. In other embodiments, user control device 100 may be powered by an external power source. For example, when connected to a wall, user control device 100 may include an interface for connecting to an external power source through the wall.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A user control device comprising:
an electronic display configured to present visual media comprising dynamic graphics and text, the electronic display comprising:
a substantially transparent front surface through which the visual media presented by the electronic display are visible; and
a substantially transparent rear surface, opposite the front surface, through which the visual media presented by the electronic display are visible;
an orientation sensor configured to detect an orientation of the electronic display; and
a controller configured to modify the visual media presented by the electronic display based on the orientation of the electronic display such that the visual media are:
presented as non-mirrored images that appear non-mirrored when viewed through the front surface and appear mirrored when viewed through the rear surface, in response to a determination that the electronic display has a first orientation; and
presented as mirrored images that appear mirrored when viewed through the front surface and appear non-mirrored when viewed through the rear surface, in response to a determination that the electronic display has a second orientation.

2. The user control device of claim 1, wherein:
the user control device is a thermostat comprising a temperature sensor configured to measure a temperature of a building space in which the thermostat is located; and
the controller is configured to operate the thermostat to control the temperature of the building space.

3. The user control device of claim 1, further comprising:
a housing coupled to the electronic display and containing the controller and the orientation sensor; and
a hinge coupled to the housing and configured to hingedly connect the housing to a mounting surface to allow the housing and the electronic display to pivot relative to the mounting surface.

4. The user control device of claim 3, further comprising a wall plate fixed to the mounting surface and hingedly connected to the housing via the hinge;
wherein the housing is hingedly connected to the mounting surface via the wall plate.

5. The user control device of claim 3, wherein:
the electronic display comprises a bottom edge coupled to the housing and a top edge opposite the bottom edge; and
the hinge is coupled to the housing such that the housing and the electronic display pivot about an axis substantially parallel to both the bottom edge and the top edge.

6. The user control device of claim 3, wherein:
the electronic display comprises a first side edge coupled to the housing and a second side edge opposite the first side edge; and
the hinge is coupled to the housing such that the housing and the electronic display pivot about an axis substantially parallel to both the first side edge and the second edge.

7. The user control device of claim 1, wherein:
the orientation sensor is configured to configured to detect the orientation of the electronic display relative to a direction of gravity; and
the controller is configured to determine whether the electronic display has the first orientation or the second orientation based on the orientation of the electronic display relative to the direction of gravity.

8. The user control device of claim 7, wherein the controller is configured to cause the electronic display to display a level graphic that indicates the orientation of the electronic display relative to the direction of gravity.

9. The user control device of claim 7, wherein the controller is configured to rotate the visual media to maintain a stable orientation of the visual media relative to the direction of gravity.

10. The user control device of claim 7, wherein the controller is configured to determine that the electronic display has:
the first orientation in response to a determination that a component of the direction of gravity points from a top edge of the electronic display toward a bottom edge of the electronic display; and
the second orientation in response to a determination that the component of the direction of gravity points from the bottom edge of the electronic display toward the top edge of the electronic display.

11. The user control device of claim 1, further comprising a position sensor configured to detect a position of a user relative to the electronic display;
wherein the controller is configured to determine whether the electronic display has the first orientation or the second orientation based on the position of the user relative to the electronic display.

12. The user control device of claim 11, wherein the controller is configured to determine that the electronic display has:
the first orientation in response to a determination that the user is positioned to view the visual media through the front surface of the electronic display; and
the second orientation in response to a determination that the user is positioned to view the visual media through the rear surface of the electronic display.

13. The user control device of claim 1, wherein:
the visual media comprise installation or de-installation instructions; and
the controller is configured to cause the instructions to be presented as:
non-mirrored images while the electronic display is oriented upright during installation or de-installation;
mirrored images while the electronic display is oriented upside down during installation or de-installation.

14. A method for operating a user control device, the method comprising:
presenting visual media comprising dynamic graphics and text via an electronic display of the user control device, the electronic display comprising:
a substantially transparent front surface through which the visual media presented by the electronic display are visible; and
a substantially transparent rear surface, opposite the front surface, through which the visual media presented by the electronic display are visible;
detecting the orientation of the electronic display using an orientation sensor; and
modifying the visual media presented by the electronic display based on the orientation of the electronic display such that the visual media are:
presented as non-mirrored images that appear non-mirrored when viewed through the front surface and appear mirrored when viewed through the rear surface, in response to a determination that the electronic display has a first orientation; and
presented as mirrored images that appear mirrored when viewed through the front surface and appear non-mirrored when viewed through the rear surface, in response to a determination that the electronic display has a second orientation.

15. The method of claim 14, wherein the orientation detected by the orientation sensor is an orientation of the electronic display relative to a direction of gravity;
the method further comprising determining whether the electronic display has the first orientation or the second orientation based on the orientation of the electronic display relative to the direction of gravity.

16. The method of claim 15, further comprising determining that the electronic display has:
the first orientation in response to a determination that a component of the direction of gravity points from a top edge of the electronic display toward a bottom edge of the electronic display; and
the second orientation in response to a determination that the component of the direction of gravity points from the bottom edge of the electronic display toward the top edge of the electronic display.

17. The method of claim 15, further comprising causing the electronic display to display a level graphic that indicates the orientation of the electronic display relative to the direction of gravity.

18. The method of claim 15, further comprising rotating the visual media to maintain a stable orientation of the visual media relative to the direction of gravity.

19. The method of claim 14, further comprising:
detecting a position of a user relative to the electronic display using a position sensor; and
determining whether the electronic display has the first orientation or the second orientation based on the position of the user relative to the electronic display.

20. The method of claim 19, further comprising determining that the electronic display has:
the first orientation in response to a determination that the user is positioned to view the visual media through the front surface of the electronic display; and
the second orientation in response to a determination that the user is positioned to view the visual media through the rear surface of the electronic display.
